(19) United States
(12) Patent Application Publication
(10) Pub. No.: US 2026/0011491 A1
(43) Pub. Date: Jan. 8, 2026

(54) METHOD FOR PREPARING GREEN-BODY CHIP OF THREE-TERMINAL MULTI-LAYER CERAMIC CAPACITIVE FILTER

(71) Applicant: GUANGDONG VIIYONG ELECTRONIC TECHNOLOGY CO., LTD., Luoding, Yunfu (CN)

(72) Inventors: Musheng HUANG, Luoding, Yunfu (CN); Guanglin HUANG, Luoding, Yunfu (CN); Mengda JIANG, Luoding, Yunfu (CN); Xianjun LIN, Luoding, Yunfu (CN); Yong XIANG, Luoding, Yunfu (CN)

(21) Appl. No.: 19/125,041

(22) PCT Filed: Oct. 27, 2023
(86) PCT No.: PCT/CN2023/127117

§ 371 Date: Apr. 28, 2025

(30) Foreign Application Priority Data
Oct. 28, 2022 (CN) 202211332469.6

(51) Int. Cl. H01G 4/005; H01G 4/12; H01P 1/20; H01P 11/00

(52) U.S. Cl. CPC H01G 4/005; H01G 4/12; H01P 1/20; H01P 11/007

(57) ABSTRACT

A method for preparing a green-body chip of three-terminal multi-layer ceramic capacitive filter is provided. The method includes: providing a printing plate which includes a pattern of a tabbed electrode and a pattern of a through electrode, the pattern of the tabbed electrode and the pattern of the through electrode, an avoiding portion is provided on a position of both sides of the through electrode corresponding to the tab of the tabbed electrode. A supporting pattern is provided on both ends of the tabbed electrode; placing the printing plate and performing electrode printing on the green sheet after casting; stacking the green sheet after printing according to a certain offset, and laminating after stacking to obtain a block; dicing the block to obtain the green-body chip of three-terminal multi-layer ceramic capacitive filter.

### CROSS REFERENCE TO RELATED APPLICATION

This application is a National Application of PCT/CN2023/127117 filed on Oct. 27, 2023, which claims priority to Chinese Patent Application No. 202211332469.6 filed on Oct. 28, 2022, the entire contents both of which are hereby incorporated by reference.

### FIELD OF TECHNOLOGY

The following relates to the technical field of multi-layer chip ceramic capacitors, and in particular to the technical field of manufacturing of three-terminal multi-layer ceramic capacitive filter.

### BACKGROUND

To meet the needs of electronic equipment that is constantly developing toward miniaturization, large capacity, high reliability, and low cost, multi-layer ceramic chip capacitors (MLCC) have also rapidly developed accordingly: technology continues to advance, materials are constantly updated, varieties keep expanding, volume continues to shrink, and performance steadily improves. Miniaturized and high-capacitance series products are tending to be standardized and generalized. The three-terminal multi-layer ceramic capacitive filter, as a new type of chip component that combines both a parallel multi-layer ceramic dielectric and a feedthrough capacitor composite structure, has obvious advantages in replacing high-capacitance MLCC and low-inductance MLCC for mobile communications and IC I/O filtering, which can effectively improve filtering efficiency and reduce spatial layout due to its special structural design and functional features.

The three-terminal multi-layer ceramic capacitive filter has two layers of different electrode shapes, where in one layer is a tabbed X-axis through electrode, and the other layer is a Y-axis through electrode. However during electrode pattern printing on green sheets, penetration of slurry leads to phenomena such as slurry seepage, serrations, burrs, and even electrical bridging between the Y-axis through electrode and tabs of the tabbed X-axis through electrode.

### SUMMARY

An aspect relates to a method for preparing a green-body chip of three-terminal multi-layer ceramic capacitive filter, which has advantages of avoiding undesirable phenomena such as slurry seepage, serrations, and burrs between electrodes, saving machine adjustment time, enhancing internal slurry and film utilization rates, optimizing and simplifying a printing process, and improving production efficiency.

The present application is achieved through the following technical solution:

a method for preparing a green-body chip of three-terminal multi-layer ceramic capacitive filter, including the following steps:
providing a printing plate and a green sheet after casting, wherein, the printing plate includes a pattern of a tabbed electrode and a pattern of a through electrode, the pattern of the tabbed electrode and the pattern of the through electrode are alternatively arranged by rows or columns, a tab is provided on a left side and a right side of the pattern of the tabbed electrode, an avoiding portion is provided on a position of both sides of the through electrode corresponding to the tab of the tabbed electrode;
placing the printing plate and performing electrode printing on the green sheet after casting, to obtain a dielectric film;
stacking the dielectric film according to a certain offset, and laminating after stacking to obtain a block;
dicing the block to obtain the green-body chip of three-terminal multi-layer ceramic capacitive filter.

Furthermore, it includes:

in the same column of the tabbed electrode, a supporting pattern is provided between each tabbed electrode and a cutting line located on both upper and lower side in a column direction, and the supporting pattern is not connected to the tabbed electrode; wherein, the cutting line is located between two adjacent patterns of the tabbed electrode in the column direction.

Furthermore, two adjacent supporting patterns are connected to each other and cross the cutting line. This design ensures that during dicing, there are no gaps at the cutting line, a dicing surface becomes more even, and reduces the phenomena such as burrs generation, dicing surface deformation.

The length of the supporting pattern is equal to the width of the long axis of the tabbed electrode.

The pattern of the avoiding portion is an arc concave toward an interior of the through electrode.

The distance between two end points of the arc is larger than the width of the tab of the tabbed electrode.

The pattern of the avoiding portion is in a rectangular shape.

The length of the side of the rectangular shape directly facing the tab is larger than the width of the tab of the tabbed electrode.

By providing the avoiding portion on a position where both sides of the through electrode directly face the tab of the tabbed electrode, this method for preparing a green-body chip of three-terminal multi-layer ceramic capacitive filter of the present application ensures that the distance between the tab and the through electrode is significantly increased. This prevents a slurry seepage from connecting electrodes, saves machine adjustment time, improves utilization rate of internal slurry and film, optimizes and simplifies printing process, and enhances production efficiency. Furthermore, by providing the supporting pattern at a position between the cutting line on an upper side and a lower side in the column direction and the tabbed electrode pattern, it prevents the block from damaging electrodes or deforming due to uneven stress during laminating, which improves a laminated bread-like shape of high-capacitance chips and reduces sintered electrode warping phenomena. This further guarantees quality of the green-body chip of three-terminal multi-layer ceramic capacitive filter.

For the sake of a better understanding and implementation, the present application is described in detail below with reference to drawings.

### BRIEF DESCRIPTION

Some of the embodiments will be described in detail, with references to the following Figures, wherein like designations denote like members, wherein:

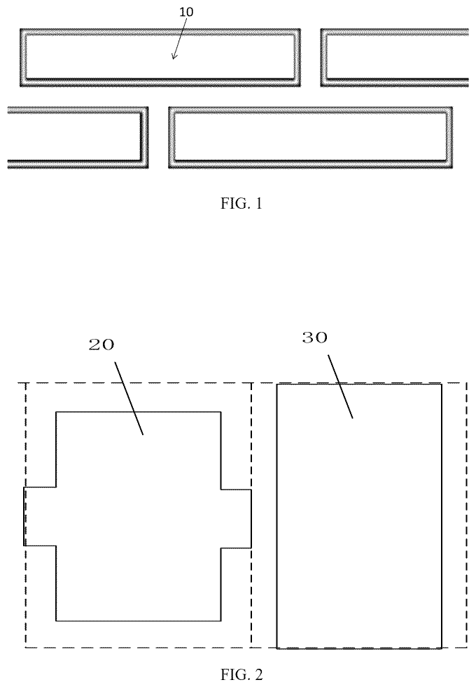

FIG. 1 shows a schematic diagram of an electrode pattern of regular ceramic capacitors;

FIG. 2 shows a schematic diagram of the electrode pattern of three-terminal multi-layer ceramic capacitive filter in a traditional process;

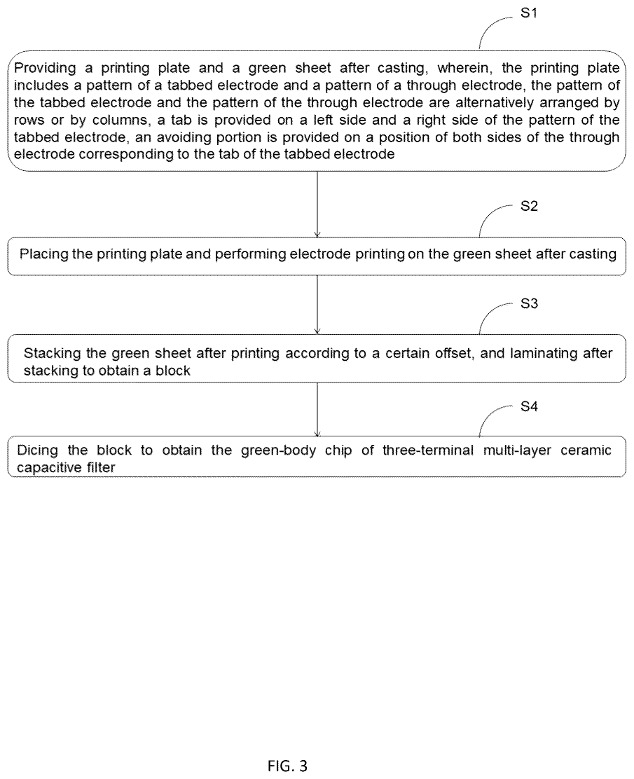

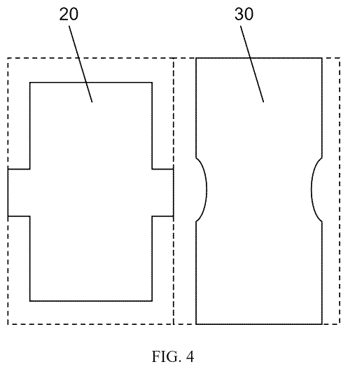

FIG. 3 shows a method for preparing a green-body chip of three-terminal multi-layer ceramic capacitive filter of the present application;

FIG. 4 shows a schematic diagram of the arc-shaped electrode pattern of a through electrode of the present application;

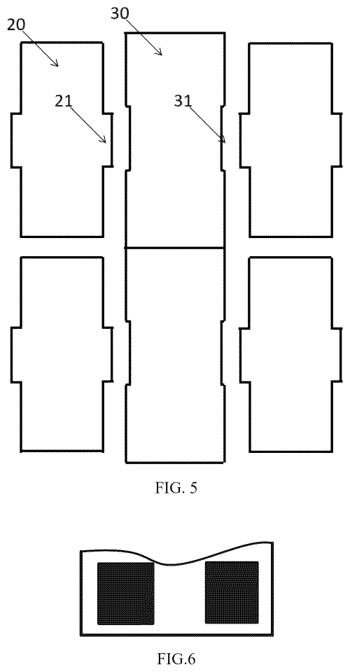

FIG. 5 shows a schematic diagram of the rectangular-shaped electrode pattern of a through electrode of the present application;

FIG. 6 shows a schematic diagram of a block deformation after laminating; and

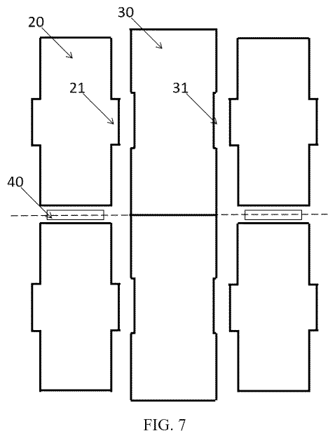

FIG. 7 shows a schematic diagram of the electrode pattern with a supporting pattern of the

present application.

### DETAILED DESCRIPTION

In order to make the technical solution and advantages of the present application more clear, the embodiments of the present application will be described in further detail below with reference drawings.

It should be clear that the described embodiments are merely a part rather than all of the embodiments of the present application. All other embodiments obtained by a person of ordinary skill in the art based on the embodiments of the present application without creative efforts shall fall within the protection scope of the embodiments of the present application.

Terms used in the embodiments of the present application are only for describing specific embodiments, and are not intended to limit the embodiments of the present application. As used in the embodiments of the present application and the appended claims, the singular forms “a”, “the” and “this” are intended to include the plural forms, unless the context clearly indicates other meanings. It should be understood that the term “and/or” used herein refers to and includes any or all possible combinations of one or more of the associated listed items.

When the following description hereinafter refers to the accompanying drawings, the same reference numerals in different drawings represent the same or similar elements, unless otherwise represented. The implementation manners described in the following exemplary embodiments do not represent all implementation manners consistent with the present application. Instead, they are merely examples of devices and methods consistent with some aspects of the present application described as detailed in the appended claims. In the description of the present application, it should be understood that terms “first”, “second” and “third” are only used to distinguish similar objects, are unnecessarily used to describe a specific order or sequence, and cannot be understood as indicating or implying relative importance. A person of ordinary skill in the art may understand specific meanings of the above-mentioned terms in the present application based on the specific situation.

In addition, in the description of the present application, unless otherwise specified, “a plurality of” means two or more. “And/or”, which describes a relationship of associated objects, indicates that three relations may be presented, for example, A and/or B may indicate three cases: A is present alone, A and B are present at the same time, or B is present alone. The character “/” herein generally indicates that the associated objects are in an “or” relationship.

FIG. 1 and FIG. 2 are accompanied to illustrate a three-terminal multi-layer capacitive filter. FIG. 1 is a schematic diagram of an electrode pattern of regular ceramic capacitor, FIG. 2 is a schematic diagram of an electrode pattern of an existing three-terminal multi-layer ceramic capacitive filter. In FIG. 1, the regular ceramic capacitor is composed of a plurality of identical electrode patterns 10, whereas in FIG. 2, electrodes of the three-terminal multi-layer ceramic capacitive filter are composed of two types of electrodes with different shapes: a tabbed electrode 20 and a through electrode 30.

Based on existing common knowledge, the three-terminal multi-layer ceramic capacitive filter is composed of alternatively stacked tabbed electrodes and through electrodes. A tab 21 of the tabbed electrode and the through electrode 30 are perpendicular to each other. There are four termination positions of the three-terminal multi-layer ceramic capacitive filter: both sides of the through electrode 30 and locations of two tabs 21, all of which are terminated with electrode material.

Compared with the regular ceramic capacitor, the distance between the two tabs 21 of the tabbed electrode 20 and the through electrode 30 in the three-terminal multi-layer ceramic capacitive filter is significantly smaller than the distance between two adjacent electrode patterns in the regular ceramic capacitor. Therefore, when printing electrode of the three-terminal multi-layer ceramic capacitive filter, a slurry seepage is prone to occur between the two tabs 21 of the tabbed electrode 20 and the adjacent two through electrodes 30, resulting in a connection between the tabs 21 and the through electrodes 30. Under the condition of electrode connection, during termination of three-terminal multi-layer ceramic capacitive filter, a portion of the through electrodes 30 where slurry seepage occurs is connected to the tabbed electrode 20, causing a short circuit failure.

Regarding technical issues mentioned in Background, the present application provides a method for preparing a green-body chip of three-terminal multi-layer ceramic capacitive filter. This method requires a printing plate and a green sheet after casting. An electrode pattern is designed on the printing plate. The electrode pattern includes a pattern of the tabbed electrode 20 and a pattern of the through electrode 30. The pattern of the tabbed electrode 20 and the pattern of the through electrode 30 are alternatively arranged in entire rows or entire columns. An avoiding portion 31 is provided on the through electrode 30 opposite to the tab 21 of the pattern of the tabbed electrode 20. Printing is performed on the green sheet after casting using the printing plate with a designed electrode pattern and obtain a dielectric film. After a drying treatment is conducted on the dielectric film, stacking, laminating and finally dicing is performed to obtain a green-body chip.

According to embodiments of the method of the present application, the margin between the tab 21 of the tabbed electrode 20 and the through electrode 30 is increased by adopting an avoidance design. This reduces printing issues such as burrs or electrode connectivity caused by internal electrode slurry seepage, reduces defects, saves machine adjustment time, decreases internal slurry waste and film sheet waste, enhances utilization rates of internal slurry and film sheets and improves production efficiency.

With reference to FIG. 3, the method for preparing a green-body chip of three-terminal multi-layer ceramic capacitive filter of the present application is described. In embodiments, the method includes the following steps:

S1: Providing the printing plate and the green sheet after casting, wherein, the printing plate includes the pattern of the tabbed electrode 20 and the pattern of the through electrode 30. The pattern of the tabbed electrode 20 and the pattern of the through electrode 30 are arranged by rows or by columns at intervals, the tab 21 is provided on a left side and a right side of the tabbed electrode 20, the avoiding portion is provided on a position of both sides of the through electrode 30 corresponding to the tab 21 of the tabbed electrode 20.

The three-terminal multi-layer ceramic capacitive filter is obtained by printing an electrode pattern on the green sheet after casting, followed by processes such as stacking, laminating, dicing, debinding, sintering, tumbling, termination, and termination firing.

In a process from printing to dicing, each step affects quality of the green-body chip. If conditions such as slurry seepage, burrs occur during printing process, it may cause a side electrode of the capacitor to connect to a side surface of the through electrode 30, resulting in a short circuit of the capacitor.

During a dicing process, if dicing position deviation occurs, it results in a large margin on one side and a small margin on the other side. A breakdown or a short circuit easily occurs in the side with the small margin.

As shown in FIG. 1, an electrode pattern in existing process is: a through electrode 30 is in a rectangular shape, with its long side directly facing a tab 21 of a tabbed electrode 20. The shortest distance between the tab 21 of the tabbed electrode 20 and the through electrode 30 is the margin distance. Since the overlapping area of electrodes directly affects capacitance of a capacitor, the electrode pattern changes with design modifications. For high-capacitance capacitors, a protruding tab 21 of the tabbed electrode 20 compresses the margin distance, causes phenomena such as slurry seepage between the tab 21 and long sides of the rectangular shape of the through electrode 30 during printing process, burrs and connection between the long side of the through electrode 30 and the tab 21 after termination, resulting in a chip short circuit failure.

In present application, the avoiding portion is provided on a position of the through electrode 30 directly facing the tab 21 of the tabbed electrode 20, which enlarges the distance between an edge of the tab 21 and the through electrode 30, thus avoiding slurry seepage etc.

S2: Placing the printing plate and performing electrode printing on the green sheet after casting to obtain a dielectric film.

S3: Stacking the dielectric film according to a certain offset, then laminating after stacking to obtain a block.

Stacking is stacking the dielectric film according to the certain offset to obtain the block before laminating. There are two different electrode patterns in the three-terminal multi-layer ceramic capacitive filter. In order to ensure that pattern of each layer does not coincide with patterns of an upper layer and a lower layer, each diced capacitor is alternately stacked in a XYXY configuration. An offset is required to be set for stacking a X-layer dielectric film and a Y-layer dielectric film, wherein the offset refers to the number of electrode layers stacked in a cycle.

S4: Dicing the block to obtain the green-body chip of three-terminal multi-layer ceramic capacitive filter.

The block after stacking may be diced according to length and width of each chip to obtain three-terminal multi-layer ceramic capacitive filter green bodies. Position of dicing affects margins of long axis and short axis of the capacitor green body. The margin of the long axis is determined by the tabbed electrode 20, the margin of the short axis is determined by the through electrode 30. The position of dicing affects performance of the three-terminal multi-layer ceramic capacitive filter. After dicing, margins of the long axis and the short axis fall within a set range to prevent a chip from short-circuiting or breakdown.

As shown in FIG. 7, in an embodiment, in the same column of the tabbed electrode 20 on the printing plate, and between each pattern of the tabbed electrode 20 and cutting lines on both upper and lower sides in the column direction, a supporting pattern 40 is provided respectively, and the supporting pattern 40 is not connected to the pattern of the tabbed electrode 20; wherein, the cutting line is located between two adjacent patterns of the tabbed electrode 20 in the column direction.

In an original design, relatively large distance exists between both ends of the tab 21 of the tabbed electrode 20 and an edge of the chip to prevent a connection between the tabbed electrode 20 and the through electrode 30 after termination, which causes capacitor short-circuiting. Under the original design, during laminating, relatively large gaps exist at both ends of the tab 21 of the tabbed electrode 20. After a central part of the block is compacted, gaps along both sides of a cutting line causes uneven force distribution on both sides of the cutting line during laminating process. This results in downward concave deformation along the cutting line and edge deformation of the block, forming a bread-like shape. In severe cases, electrode warping may occur, which leads to short circuits in the chip.

By arranging the supporting pattern 40 at a margin position, which is not connected to the tabbed electrodes 20, it not only avoids connection between the tabbed electrode 20 and through electrode 30, but also effectively resolves lamination-induced block deformation and electrode warping. After laminating, the block achieves a more regular shape, preventing uneven force distribution from causing an edge deformation of the block, forming a bread-like shape, or even compressing the internal electrodes to cause deformation of the internal electrodes.

In another embodiment, two adjacent supporting patterns 40 are connected to each other and cross the cutting line. On the one hand, this design allows for faster setting of the supporting pattern 40 on the green sheet, as a single printing of one supporting pattern 40 may support pattern of two adjacent tabbed electrodes 20. On the other hand, with the supporting pattern 40 positioned at the cutting line, there are no gaps at a dicing position during a block-dicing process. This improves stress uniformity and flatness of a dicing surface, reduces burrs, and mitigates the bread-like deformation during lamination of high-capacitance chips and warping of sintered electrodes.

As shown in FIG. 4, in an embodiment, a pattern of the avoiding portion is designed as an arc, and width of both end points of the arc is larger than width of the tab 21 of the tabbed electrode 20. A larger width of the avoiding portion ensures that an distance between the tab 21 and edge of a directly facing area is enlarged, thus further avoiding slurry seepage phenomena.

As shown in FIG. 5, in another embodiment, shape of the avoiding portion and shape of tab 21 are both rectangular. This design ensures that interval distances between the tab 21 of the tabbed electrode 20 and the edge are all equal. On one hand, this better prevents slurry seepage. On the other hand, capacitance of the capacitor is positively correlated with a directly facing area between electrodes. By designing the shape of the avoiding portion to correspond to the shape of the tab 21, it maximizes facing area utilization rate while ensuring optimal slurry seepage prevention. This design not only ensures quality of the three-terminal multi-layer ceramic capacitive filter but also improves utilization rate of a chip area.

By providing the avoiding portion on both sides of the through electrode that are directly opposite to the tab of the tabbed electrode, the present application significantly increases the distance between the tab of tabbed electrode pattern and the through electrode, thus preventing slurry seepage phenomenon that connects electrodes, saving machine adjustment time, improving utilization rate of internal slurry and film, while optimizing and simplifying the printing process and enhancing production efficiency. Furthermore, the supporting pattern is provided between the tabbed electrode and the cutting line on the upper and lower sides in the column direction. This prevents the bar from damaging electrode or deforming itself due to an uneven stress distribution during laminating process, while addressing issues such as the bread-like shape of a laminated high-capacitance chip and warping of sintered electrodes. At the same time, it ensures flatness of the dicing surface when a single three-terminal multi-layer ceramic capacitive filter is obtained, thereby enhancing product quality.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for preparing a green-body chip of three-terminal multi-layer ceramic capacitive filter, comprising the following:
providing a printing plate and a green sheet after casting, wherein, the printing plate includes a pattern of a tabbed electrode and a pattern of a through electrode, the pattern of the tabbed electrode and the pattern of the through electrode are alternatively arranged by rows or columns, a tab is provided on a left side and a right side of the pattern of the tabbed electrode, an avoiding portion is provided on a position of both sides of the through electrode corresponding to the tab of the tabbed electrode;
placing the printing plate and performing electrode printing on the green sheet after casting to;
stacking the green sheet after printing according to a certain offset, and laminating after stacking to obtain a block; and
dicing the block to obtain the green-body chip of three-terminal multi-layer ceramic capacitive filter.

2. The method for preparing a green-body chip of three-terminal multi-layer ceramic capacitive filter of claim 1, wherein
in the same column of the pattern of the tabbed electrode on the printing plate, a supporting pattern is provided between each pattern of the tabbed electrode and a cutting line located on both upper and lower side in a column direction, and the supporting pattern is not connected to the pattern of the tabbed electrode; wherein, the cutting line is located between two adjacent patterns of the tabbed electrode in the column direction.

3. The method for preparing a green-body chip of three-terminal multi-layer ceramic capacitive filter of claim 2, wherein
two adjacent supporting patterns are connected to each other and cross the cutting line.

4. The method for preparing a green-body chip of three-terminal multi-layer ceramic capacitive filter of claim 3, wherein
the length of the supporting pattern is equal to width of long axis of the pattern of the tabbed electrode.

5. The method for preparing a green-body chip of three-terminal multi-layer ceramic capacitive filter of claim 4, wherein
a pattern of the avoiding portion is an arc concave toward an interior of the through electrode.

6. The method for preparing a green-body chip of three-terminal multi-layer ceramic capacitive filter of claim 5, wherein
the distance between two end points of the arc is larger than the width of the tab of the tabbed electrode.

7. The method for preparing a green-body chip of three-terminal multi-layer ceramic capacitive filter of claim 4, wherein
the pattern of the avoiding portion is in a rectangular shape.

8. The method for preparing a green-body chip of three-terminal multi-layer ceramic capacitive filter of claim 7, wherein
the length of side of the rectangular shape directly facing the tab is larger than the width of the tab of the tabbed electrode.
